(19) United States
(12) Patent Application Publication
(10) Pub. No.: US 2010/0129631 A1
(43) Pub. Date: May 27, 2010

(54) PROTECTIVE COATING AND USE THEREOF FOR OVERHHEAD TROLLEY WIRE INSULATORS

(76) Inventors: Anett Berndt, Erlangen (DE); Rudolf Gensler, Singapore (SG); Heinrich Kapitza, Furth (DE); Sonja Leistner, Erlangen (DE); Axel Schmieder, Leipzig (DE); Heinrich Zeininger, Obermichelbach (DE)

Correspondence Address: HARNESS, DICKEY & PIERCE, P.L.C., P.O.BOX 8910, RESTON, VA, 20195, US

(21) Appl. No.: 12/451,481

(22) PCT Filed: May 2, 2008
(86) PCT No.: PCT/EP2008/055433

§ 371 Date: Nov. 13, 2009

(51) Int. Cl. C09D 5/25; B32B 5/00

(52) U.S. Cl. 428/220; 106/287.3; 106/287.34

(57) ABSTRACT

One embodiment of the present invention discloses a coating for overhead trolley wire insulators, particularly in the area of rail electrification and energy transmission, which can be produced easily and inexpensively. For this purpose, particles and micro powders, hydrophobic particles in particular, are incorporated into the protective laquer.

### PRIORITY STATEMENT

This application is the national phase under 35 U.S.C. §371 of PCT International Application No. PCT/EP2008/055433 which has an International filing date of May 2, 2008, which designated the United States of America, and which claims priority on German patent application number DE 10 2007 023 557.9 filed May 21, 2007, the entire contents of each of which are hereby incorporated herein by reference.

### FIELD

At least one embodiment of the invention generally relates to novel coatings for traction line insulators, in particular in the area of rail electrification and energy transmission.

### BACKGROUND

The long-term resistance of insulators to weathering, i.e. UV radiation, moisture and other aggressive environmental influences, has to date been ensured in that the insulators are sheathed in jackets made of materials with excellent hydrophobic characteristics. Generally these jackets of the composite insulators contain silicone and/or PTFE. The application of such jackets requires additional steps during manufacture and incurs considerable costs.

On the other hand there are polymer insulators made of epoxy casting resins and plastics reinforced with glass fibers having a duroplastic resin matrix of unsaturated polyester or epoxy resins. Often however these are not provided with an additional protective layer and are therefore not resistant to weathering. The insulating element of these polymer insulators generally consists of a solid profile or solid shaft with shields and thus just one organic material. Examples of these are glass fiber reinforced plastic insulating runners and cast resin insulators.

The long-term resistance of such low-cost single material insulators to environmental influences and weathering can only be influenced by the surface quality or roughness and is therefore unsatisfactory.

The resistance of the insulator surface to arcing in particular has not been satisfactorily resolved until now. Section insulators with glass fiber reinforced plastic insulating runners have the task of dividing the overhead line into individual switching and supply segments. These switching and supply segments are insulated from one another by the section insulators. Arcing can occur during passage through the pantographs at the section insulators and such arcing can damage the insulating runners of the section insulator.

### SUMMARY

At least one embodiment of the invention is directed to increasing the long-term resistance of the low-cost single material insulators in the open and/or to configuring the jackets for the composite insulators more economically.

The subject matter of at least one embodiment the invention includes a protective lacquer with a duroplastic plastic base for coating single material insulators and/or as a jacket for composite insulators, in which micropowders, nanoparticles and/or colloids are incorporated, which by their nature have hydrophobic functional groups.

Making the surface of the protective coating hydrophobic can reduce contamination. Coatings made to be hydrophobic with contact angles against water of greater than 90°—as a measure of hydrophobia—are more resistant to weathering than for example the conventional epoxy resin coating of roll insulators.

Incorporating hydrophobically functionalized SiO₂ nanoparticles/colloids and/or boron nitride particles in the form of prefabricated particle sols and/or micropowder in duroplastic lacquer matrices, such as polyurethane or silicone coatings, produces hydrophobic lacquer surfaces with low surface energies.

In polyurethane systems (PU) the contact angles of approx. 80° relative to water can be increased to >120°.

The SiO₂ nanoparticles and/or colloids are used for example in the form of prefabricated sols. These are commercially available for example and products from the company FEW Chemicals, Wolfen, Germany, e.g. H4109, are used.

In addition or as an alternative to the hydrophobically functionalized SiO₂ particles it has also been possible to increase hydrophobia in PU or silicone lacquers by incorporating boron nitride (BN) micropowders. The hydrophobia of the lacquer surfaces increases as the BN concentration rises. One example is a polyurethane protective lacquer, which without additions has a contact angle of 83°, while a contact angle of 105° is achieved with an addition of 10% by weight boron nitride.

The same has been observed in the case of silicone lacquer, where a pure silicone lacquer (Powersil from Wacker AG) has a contact angle of 95° (glass) or 105° (steel) and with a 10% addition of boron nitride achieves a contact angle of 122°. These values can be increased still further, as an addition of 20% by weight boron nitride produced a contact angle of 130° and an addition of 30% by weight boron nitride brought about a contact angle of 135°.

At least one embodiment of the invention has a series of advantages compared with the prior art:

Firstly very large contact angles are achieved; generally the contact angles of the inventive protective lacquer are over 110° against water, although of course in some circumstances the invention can also include protective lacquers with smaller contact angles.

Secondly it is an economical variant for producing the protective lacquer, as only small quantities, for example 1 to 10% by weight, preferably 3 to 7% by weight and particularly preferably up to 5% by weight of hydrophobic SiO₂ nanoparticles are required.

Boron nitride micropowders can be incorporated in the protective lacquer in quantities from 5 to 60% by weight, preferably in quantities between 5 and 50% by weight, particularly preferably in quantities between 10 and 35% by weight, as in the example embodiments.

The hydrophobized nanoparticles can be incorporated simply by being mixed in with the lacquer components. Special mixing apparatuses, such as bead mills, torus mills, etc., are not necessary. The distribution of the nanoparticles in the lacquer is very homogeneous, as the particles are incorporated as stable sols.

### DETAILED DESCRIPTION OF THE EXAMPLE EMBODIMENTS

The invention is described in more detail below again with reference to an example embodiment.

Coating of plastic substrates for outdoor applications for rail electrification and energy transmission.

Lacquering with the inventively modified PU lacquers, which are highly suitable as the lacquer matrix for outdoor applications due to high weathering resistance, remains hydrophobic in weathering tests over 1000 hours with alternating UVA radiation of >10 mW/cm² over 650 hours, intensive spraying (650 hours) and storage at 50° C. over 50 hours.

Before weathering a contact angle of 114° was measured, during the course of the tests the contact angle reduces to 90°. In comparison the contact angle for the commercially available PU lacquers that have not been inventively modified is around 80°, dropping to 70° during the course of the tests.

Layer thicknesses were approx. 10 to 40 μm, in particular between 15 and 30 μm, particularly preferably approx. 20 μm

With silicone lacquers with added boron nitride (BN) the contact angles remain around values >110° even after the weathering test. The silicone coatings with added BN are therefore the most stable with regard to weathering. One exemplary embodiment of such a silicone lacquer can be made from 810 g Powersil 567 (Wacker AG) and 90 g boron nitride from HCStarck.

At least one embodiment of the invention relates to a novel coating for traction line insulators, in particular in the area of rail electrification and energy transmission, which can be produced easily and inexpensively. To this end particles and micropowders, in particular hydrophobic particles, are incorporated in the protective lacquer.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A protective lacquer with a duroplastic plastic base for at least one of coating single material insulators and as a jacket for composite insulators, in which at least one of micropowders, nanoparticles and colloids are incorporated, which by their nature have hydrophobic functional groups.

2. The protective lacquer as claimed in claim 1, wherein boron nitride is incorporated as a micropowder.

3. The protective lacquer as claimed in claim, wherein silicon dioxide (SiO₂) is incorporated in the form of at least one of nanoparticles and colloids.

4. The protective lacquer as claimed in claim 1, wherein SiO₂ particles are incorporated in the form of at least one of prefabricated sols and colloids.

5. The protective lacquer as claimed in claim 1, wherein the micropowder, the nanoparticles or the colloids are incorporated in a quantity from 0.5 to 50% by weight.

6. The protective lacquer as claimed in claim 1, wherein boron nitride micropowder is incorporated in a quantity between 5 and 60% by weight.

7. The protective lacquer as claimed in claim 1, wherein hydrophobic silicon dioxide nanoparticles are incorporated in a quantity from 1 to 10% by weight.

8. The protective lacquer as claimed in claim 1, applied in a layer thickness of approx. 20 μm.

9. A method, comprising:
using a protective lacquer with a duroplastic plastic base for at least one of coating single material insulators and as a jacket for composite insulators, in which at least one of micropowders, nanoparticles and colloids are incorporated, which by their nature have hydrophobic functional groups.

10. The protective lacquer as claimed in claim 2, wherein silicon dioxide (SiO₂) is incorporated in the form of at least one of nanoparticles and colloids.

11. The protective lacquer as claimed in claim 2, wherein SiO₂ particles are incorporated in the form of at least one of prefabricated sols and colloids.

12. The protective lacquer as claimed in claim 2, wherein the micropowder, the nanoparticles or the colloids are incorporated in a quantity from 0.5 to 50% by weight.

13. The protective lacquer as claimed in claim 2, wherein boron nitride micropowder is incorporated in a quantity between 5 and 60% by weight.

14. The protective lacquer as claimed in claim 2, wherein hydrophobic silicon dioxide nanoparticles are incorporated in a quantity from 1 to 10% by weight.

15. A protective lacquer with a duroplastic plastic base for at least one of coating single material insulators and as a jacket for composite insulators, the protective lacquer comprising:
at least one of micropowders, nanoparticles and colloids, which by their nature have hydrophobic functional groups.

16. The protective lacquer as claimed in claim 15, wherein boron nitride is incorporated as a micropowder.

17. The protective lacquer as claimed in claim 15, wherein silicon dioxide (SiO₂) is incorporated in the form of at least one of nanoparticles and colloids.

18. The protective lacquer as claimed in claim 15, wherein SiO₂ particles are incorporated in the form of at least one of prefabricated sols and colloids.
